(19) United States
(12) Patent Application Publication
(10) Pub. No.: US 2012/0084119 A1
(43) Pub. Date: Apr. 5, 2012

(54) METHOD AND SYSTEM FOR EXCESS INVENTORY MANAGEMENT

(75) Inventors: Justin L. Vandehey, Menlo Park, CA (US); Aaron Elias Berhanu, San Francisco, CA (US); Simon Levy, Menlo Park, CA (US); Justin J. Metzler, San Francisco, CA (US)

(73) Assignee: INTUIT INC., Mountain View, CA (US)

(21) Appl. No.: 12/897,674

(22) Filed: Oct. 4, 2010

(51) Int. Cl. G06Q 10/00; G06Q 30/00

(52) U.S. Cl. 705/7.31

(57) ABSTRACT

A method for managing excess inventory includes receiving a physical shipment of goods and submitting a description and expiration date of each inventory item in the physical shipment of goods to an inventory management application. The inventory management application tracks number of units of each inventory item at the merchant. The method further includes, at a predefined timeframe prior to the expiration date, receiving a notification when a forecast of the number of unit of an inventory item remaining in the inventory at the expiration date is greater than a pre-defined threshold, selecting a buyer network of a plurality of buyer networks for selling the inventory item to generate a selected buyer network, and selling the inventory item via the selected buyer network.

### BACKGROUND

In general, merchants involved in the sale of goods typically purchase the goods at a low price from suppliers and sell the goods at a higher price to customers. Because the merchants typically do not have an actual count of the number of units of the good that customers will purchase, owners of the business estimate the number of units of the good to purchase from their suppliers.

Underestimating and overestimating the number of goods can cause a loss for the merchant. If the merchant underestimates the number of units, then the merchant is unable to fulfill the demand of their customer. As a result, the merchant may suffer a loss of potential revenue from selling the goods to the customer, and may lose customers that are dissatisfied with the merchant not having the goods. If the merchant overestimates the number of units, then the merchant may lose potential revenue from being unable to purchase other goods that could be sold, and potential revenue from goods becoming obsolete or spoiling.

Continuing with the discussion, when the goods are received, the goods are placed in their inventory to sell to the customers. Over time, customers purchase the goods from the merchants. If the merchant has too few units of goods, then the merchant may reorder the goods from their supplier. If the merchant has too many units, then the merchant may have an in-store sale to sell the excess units to their customers.

### SUMMARY

In general, in one aspect, the invention relates to a method for managing excess inventory. The method includes receiving a physical shipment of goods and submitting a description and expiration date of each inventory item in the physical shipment of goods to an inventory management application. The inventory management application tracks number of units of each inventory item at the merchant. The method further includes, at a predefined timeframe prior to the expiration date, receiving a notification when a forecast of the number of unit of an inventory item remaining in the inventory at the expiration date is greater than a pre-defined threshold, selecting a buyer network of a plurality of buyer networks for selling the inventory item to generate a selected buyer network, and selling the inventory item via the selected buyer network.

In general, in one aspect, the invention relates to a system for managing excess inventory. The system includes an inventory management application and a merchant transaction application. The inventory management application includes functionality to obtain a description of an inventory item in an inventory of a merchant, a number of units of the inventory item, and an expiration date for the inventory item, track sales of the inventory item by reducing a number of units of the inventory item according to the sales, and notify, at a first predefined timeframe prior to the expiration date, the merchant of the expiration date when a forecast of the number of unit of the inventory item remaining in the inventory is greater than a pre-defined threshold. The merchant transaction application includes functionality to present the merchant with a plurality of buyer networks for selling the inventory item, receive, from the merchant, a selection of a first buyer network of the plurality of buyer networks to obtain a first selected buyer network, and offer, at the first predefined timeframe prior to the expiration date, the inventory item for sale on the first selected buyer network.

In general, in one aspect, the invention relates to a computer readable storage medium comprising computer readable program code embodied therein for causing a computer system to perform a method for managing excess inventory. The method includes obtaining a description of an inventory item in an inventory of a merchant, a number of units of the inventory item, and an expiration date for the inventory item, tracking sales of the inventory item by reducing a number of units of the inventory item in inventory according to the sales, notifying, at a first predefined timeframe prior to the expiration date, the merchant when a forecast of the number of units of the inventory item remaining at the expiration date in the inventory is greater than a pre-defined threshold, and referring the merchant to a merchant transaction system. The merchant transaction system presents the merchant with a plurality of buyer networks for selling the inventory item, receives, from the merchant, a selection of a first buyer network of the plurality of buyer networks to obtain a first selected buyer network, and offers, at the first predefined timeframe prior to the expiration date, the inventory item for sale on the first selected buyer network.

In general, in one aspect, the invention relates to a computer readable storage medium comprising computer readable program code embodied therein for causing a computer system to perform a method for managing excess inventory. The method includes receiving a physical shipment of goods and submitting a description and expiration date of each inventory item in the physical shipment of goods to an inventory management application, wherein the inventory management application tracks number of units of each inventory item at the merchant. The method further includes, at a predefined timeframe prior to the expiration date, receiving a notification when a forecast of the number of unit of an inventory item remaining in the inventory at the expiration date is greater than a pre-defined threshold, selecting a buyer network of a plurality of buyer networks for selling the inventory item to generate a selected buyer network, and selling the inventory item via the selected buyer network.

Other aspects of the invention will be apparent from the following description and the appended claims.

### BRIEF DESCRIPTION OF DRAWINGS

FIGS. 1A-1B show a schematic diagram of a system in accordance with one or more embodiments of the invention.

FIGS. 2-6 show flowcharts in accordance with one or more embodiments of the invention.

FIG. 7 shows an example in accordance with one or more embodiments of the invention.

FIG. 8 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for excess inventory management. Specifically, embodiments of the invention track a merchant's sale of units of inventory items to forecast the number of units that the merchant will have at the expiration date of the inventory item. If the forecasted number is more than a pre-defined threshold, then the merchant is referred to a merchant transaction system to sell the excess number of units of the inventory item. Through the merchant transaction system, the merchant can offer the excess number of units of the inventory for sale to a specific buyer network selected by the merchant. Further, the merchant transaction system allows the merchant to define which set of potential buyers may view and purchase the excess inventory.

A merchant, as used herein, is a business entity that sells inventory items. Specifically, the merchant may maintain a physical store at a geographic location, in which customers visit to purchase items. Further, the merchant may sell inventory items to customers via a network site (e.g., Internet site, website) that excludes the merchant transaction system (discussed below). In one or more embodiments of the invention, the merchant may or may not have or be eligible for a merchant account for processing credit cards. However, in some embodiments of the invention, for a business entity to be a merchant, the business entity must have a merchant account and be capable of accepting credit cards.

In one or more embodiments of the invention, a merchant is a retailer. In such embodiments, all inventory items added to the merchant's inventory are intended to be resold by the merchant. In one or more embodiments of the invention, outside of the merchant transaction system, the customers of the merchant are the end customers. In other words, the merchant is a retailer in such embodiments, rather than the merchant a distributor of goods that sells to retailers outside of the merchant transaction system.

In one or more embodiments of the invention, the merchant may be a manufacturer. In such embodiments, inventory items added to the merchant's inventory may be combined, modified, or otherwise used to construct the merchant's produced goods for sale to customers. In one or more embodiments of the invention, the merchant's produced goods may be excluded from sale on the merchant transaction system. Alternatively, in one or more embodiments of the invention, the merchant's produced goods may be a part of the merchant transaction system. Further, in such embodiments, merchants that are manufacturers may set a parameter in the buyer network that differentiates between merchants that are retailers and merchants that are manufacturers.

As used herein, an entity (e.g., merchant, general consumer, non-profit organization) performs an action when an agent of the entity, a computer system for the entity, or individual or group related to the entity performs an action on behalf of the entity. Similarly, information is presented to the entity when information is presented to an agent of the entity, a computer system for the entity, or individual or group related to the entity performs an action on behalf of the entity.

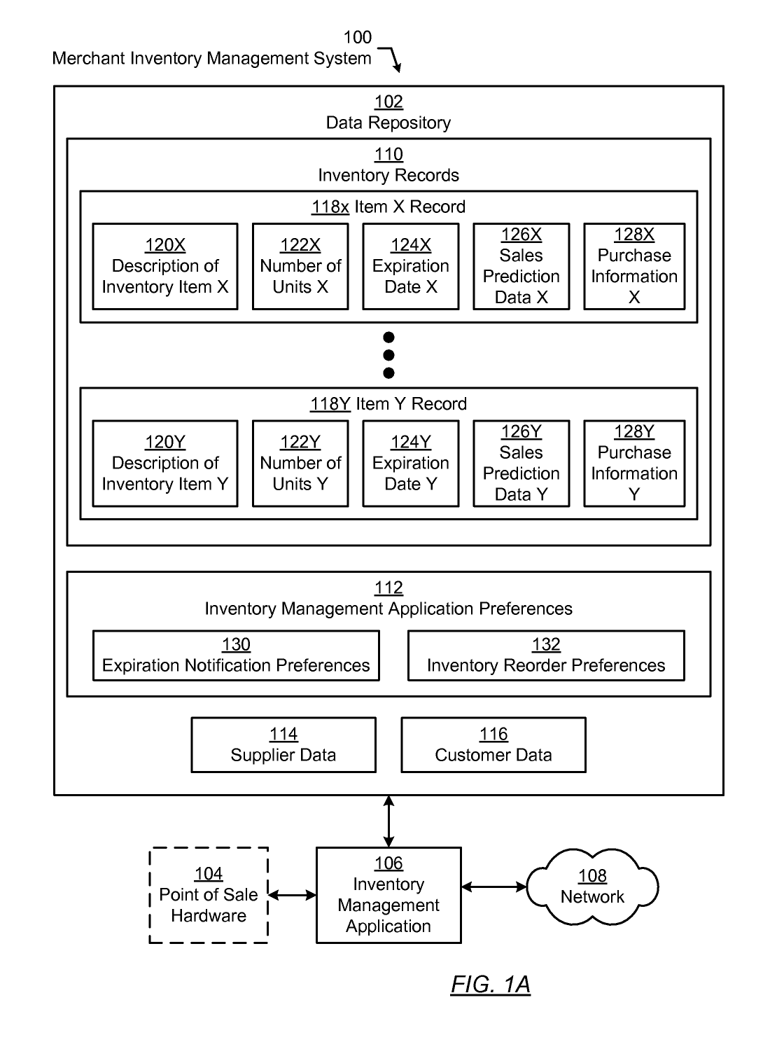

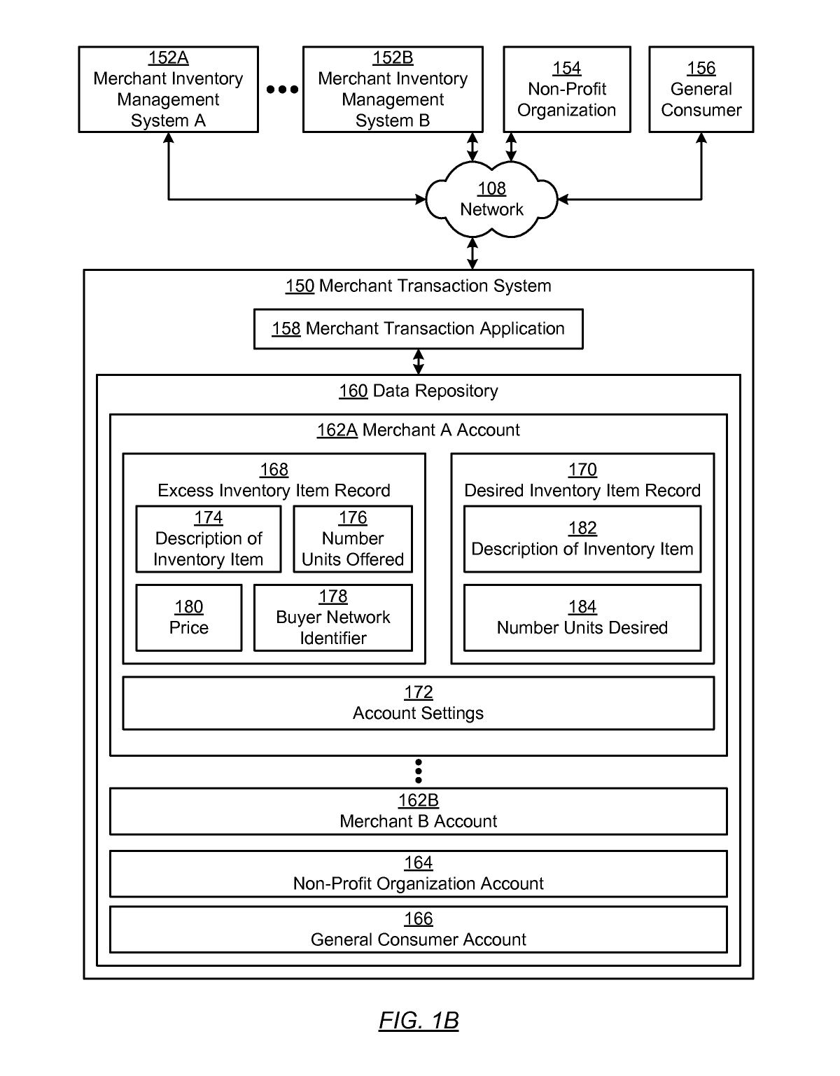

FIGS. 1A-1B show a schematic diagram of a system in accordance with one or more embodiments of the invention. FIG. 1A shows a schematic diagram of a merchant inventory management system (100) in accordance with one or more embodiments of the invention. In general, the merchant inventory management system (100) manages the merchant's inventory of inventory items. For example, the merchant inventory management system (100) tracks the number of units of each inventory item that the merchant has in inventory. The merchant inventory management system (100) may also assist the merchant in ordering new inventory items, restocking existing inventory items, tracking customers and suppliers, selling inventory items, and performing other functions related to inventory. Furthermore, the merchant inventory management system (100) may be a part of a financial management system for managing the finances of the merchant. For example, the financial management system may include functionality to manage the merchant's customer lists (e.g., track customers' contact information, buying preferences, and discounts), manage the merchant's payroll (e.g., track employee information, generate paychecks, and perform other employee related actions), and/or perform accounting functions for the merchant (e.g., generate tax forms, generate accounting reports). A financial management system having the merchant transaction system may include functionality to perform additional functions without departing from the scope of the invention.

In one or more embodiments of the invention, the merchant inventory management system (100) may include a data repository (102), point of sale hardware (104), and an inventory management application (106). Each of these components is discussed below.

In general, in one or more embodiments of the invention, a data repository is any type of storage unit and/or device (e.g., a file system, database, collection of tables, or any other storage mechanism) for storing data. Specifically, the data repository may include hardware and/or software. Further, the data repository may include multiple different storage units and/or devices. The multiple different storage units and/or devices may or may not be of the same type or located at the same physical site.

The data repository (102) shown in FIG. 1A stores data for the merchant inventory management system. In one or more embodiments of the invention, the data in the data repository (102) includes inventory records (110), inventory management application preferences (112), supplier data (114), and customer data (116). Each of the types of data is discussed below.

Inventory records (110) correspond to a collection of data about the merchant's inventory. Each inventory record (e.g., inventory X record (118X), inventory Y record (118Y)) provides information about a corresponding inventory item. Further, an inventory record may or may not be related to another inventory record in the data repository (102). Specifically, a relationship between inventory records may exist when the inventory records correspond to products of the same type with different attributes.

The following is an example of how different inventory records may relate to each other. In the following example, consider the scenario in which the merchant has clothing of a specific brand and a specific model (e.g., a t-shirt from a specific manufacturer). To accommodate the merchant's customers, the merchant may have multiple different sizes and multiple different colors. Different storage techniques may be used to store the merchant's clothing and capture that the merchant has multiple different sizes and multiple different colors of the same brand and model of clothing. For example, the clothing may be stored in separate inventory records (e.g., inventory X record (118X), inventory Y record (118Y)) for each different size and/or color. By way of another example, a separate inventory record (e.g., inventory X record (118X), inventory Y record (118Y)) may exist for each different size and/or color, where each of the separate inventory records reference the same set of shared attributes denoting the specific brand, specific mode, sales prediction data, and/or other shared attributes. As another example, the same brand and model of clothing may have a single inventory record (e.g., inventory X record (118X), inventory Y record (118Y)) for all sizes and/or colors. In the example, attributes within the single inventory record may store the amount of each different size and color.

In one or more embodiments of the invention, the information in the inventory record (e.g., inventory X record (118X), inventory Y record (118Y)) includes a description of the inventory item (e.g., description of inventory item X (120X), description of inventory item Y (120Y)), the number of units of the inventory item (e.g., number of units X (122X), number of units Y (122Y)), the expiration date of the inventory item (e.g., expiration date X (124X), expiration date Y (124Y)), sales prediction data (e.g., sales prediction data X (126X), sales prediction data Y (126Y)), and purchase information (e.g., purchase information X (128X), purchase information Y (128Y)). Each type of information is discussed below.

In one or more embodiments of the invention, the description of the inventory item (e.g., description of inventory item X (120X), description of inventory item Y (120Y)) provides an identifier for the inventory item. For example, the description (e.g., description of inventory item X (120X), description of inventory item Y (120Y)) may include a textual phrase describing the inventory item, a stock-keeping unit (SKU) identifier or other product code, attributes of the inventory item (e.g., size, place of origin, manufacturer, supplier of the inventory item), and/or any other descriptive information about the inventory item.

In one or more embodiments of the invention, the description of the inventory item may include a universal unique identifier that is unique for the inventory item and used for the inventory item across all merchants. Thus, multiple merchants can unambiguously reference the same inventory item. For example, the common component may be a universal product code of the inventory item. In the example, one merchant may sell an inventory item using the Universal Product Code (UPC), which matches to the UPC by a merchant wanting to buy the inventory item via the merchant transaction system (discussed below and in FIG. 1B).

In one or more embodiments of the invention, the description of the inventory item (e.g., description of inventory item X (120X), description of inventory item Y (120Y)) may be just the common component and used as an index into a centrally stored description of inventory items used by multiple merchants. Specifically, the description of the inventory item may be shared by multiple merchants. Thus, the description of the inventory item in the inventory records may have only an index into the shared description.

Continuing with the inventory records (110), in one or more embodiments of the invention, inventory items are sold in units. A unit is a discrete amount of the inventory item. For example, a unit may be a discrete package, a volumetric measurement unit (e.g., liters, gallons, pints, barrels, etc.), a weight measurement unit (e.g., milligrams, grams, pounds, tons, etc.), dimensional unit (e.g., inches, square inches, meters, etc.), or any other standard of measurement. Accordingly, the number of units (e.g., number of units X (122X), number of units Y (122Y)) specifies a discrete amount in accordance with one or more embodiments of the invention. The number of units (e.g., number of units X (122X), number of units Y (122Y)) may correspond to units sold, purchased, and/or remaining in inventory. Further, the number of units (e.g., number of units X (122X), number of units Y (122Y)) may identify the amount of the inventory item ordered by the merchant. The number of units (e.g., number of units X (122X), number of units Y (122Y)) may identify the amount of the inventory item received from an order in a shipment. Thus, the number of units (e.g., number of units X (122X), number of units Y (122Y)) records the amount of the inventory item.

Continuing with the item record (110), the expiration date (e.g., expiration date X (124X), expiration date Y (124Y)) is the date at which the inventory item is set to expire. Specifically, the expiration date is the date in which at most only a threshold number of units should remain in inventory. The threshold number may be zero or a minimal number. The expiration date (e.g., expiration date X (124X), expiration date Y (124Y)) may be a “sale by” date for inventory items that spoil or have a fixed shelf life, a goal date by which the merchant desires to have the inventory item sold, or another set date. For example, the expiration date (e.g., expiration date X (124X), expiration date Y (124Y)) may correspond to a date at the end of the tax year, a date at the end of a clothing season, the date marked on the inventory item, a relative date relative to when the inventory item was received (e.g., two weeks, one month, etc. from the date of receipt), or any other defined date. The expiration date (e.g., expiration date X (124X), expiration date Y (124Y)) may be defined and/or set by the merchant, manufacturer, supplier, government agency (e.g. the Food and Drug Administration), historical data obtained from the merchant transaction system, or any other source with sufficient information to identify the specific inventory good.

The sales prediction data (e.g., sales prediction data X (126X), sales prediction data Y (126Y)) in the inventory item record provides information for predicting whether only the threshold number of units of the inventory item will remain at the expiration date. For example, the sales prediction data (e.g., sales prediction data X (126X), sales prediction data Y (126Y)) may store information defining the time of the last sale of the inventory item, the frequency at which units of the inventory item are sold, changes in frequency at which the number of units of the inventory item are sold, the number of units of the inventory item sold, historical data, or other data that may be used to forecast the number of units remaining at the expiration date. The changes in frequency of units sold captures how often customers purchase a unit of the inventory item over time. For example, a popular item may have a higher frequency of units sold on the first day the item is sold by any merchant and then a lower frequency of units sold in the subsequent weeks. In the example, the changes of frequency of units sold may capture an initial frequency from initial consumer enthusiasm for purchasing the item on the first day that the item is sold as well as the subsequent lower frequency of sales caused by dwindling consumer enthusiasm for purchasing the item. In one or more embodiments of the invention, historical data includes how the item or past items sold by the merchant or similar merchants. The historical data may be based on inventory item sales data gathered from merchants via the merchant transaction system. For example, if the inventory item is Milk that expires February 25, the historical data may include sales data for Milk that expired between February 14 and September 6 of the same year or of a different year, which is already sold or is otherwise disposed. As another example, if the inventory item is Milk that expires February 25, the historical data may include sales data for Milk that expired between February 20 and February 28 of previous years.

In one or more embodiments of the invention, purchase information (e.g., purchase information X (128X), purchase information Y (128Y)) provides information about the cost to the merchant of the inventory item. Specifically, purchase information (e.g., purchase information X (128X), purchase information Y (128Y)) is the amount that the merchant paid for the inventory item. Purchase information (e.g., purchase information X (128X), purchase information Y (128Y)) may also include information about arrangements that the merchant has with their supplier regarding unused inventory items. For example, if the merchant and supplier have a buyback provision for the supplier to buy unused units from the merchant, the purchase information may provide information about the buyback provision, such as the price for the buyback, the expiration date and a relative date to the expiration date for the buyback, and/or any other buyback provisions.

Continuing with the data repository, in one or more embodiments of the invention, the inventory management application preferences (112) includes the preferences that the merchant has set for the management application. For example, the preferences (112) may include expiration notification preferences (130) and inventory reorder preferences (132).

In one or more embodiments of the invention, the expiration notification preferences (130) provide the preferences for the merchant to receive expiration notices. In one or more embodiments of the invention, the expiration notification preferences (130) may include the mode for communicating the expiration of an inventory item, a test period to test for expiring inventory items, when to issue a notification, the contents of the notification, and/or any other such information. For example, mode for communication may be text message, an email, a popup window, a pane in a window, or any other type of message. The test period may be at a specific time of day, at a specific time(s) of the week, etc. Alternatively, a default time may be used without departing from the scope of the invention.

In one or more embodiments of the invention, the notification may include a variety of content. For example, the notification may include the identifier of the inventory item, the purchase price of the inventory item, a consequence associated with not selling the inventory, an urgency level, and a reference to a merchant transaction system (discussed below and in FIG. 1B). The consequence associated with the inventory item may include potential interest that could be earned on income from selling the inventory item, potential sales price and tax consequences of selling the inventory item at a loss, tax consequences of donating the inventory item, and other potential costs or gains.

In one or more embodiments of the invention, the urgency level may be dependent on the length of time to the expiration date, the number of items that will remain in inventory if the items are not sold by the expiration date, and the potential loss to the merchant for not selling the inventory item, or a combination thereof. The urgency level may be defined on a scale. For example, the scale may be low urgency, medium urgency, and high urgency. In the example, the urgency level may be displayed in the notification as red for high urgency, yellow for medium urgency, or green for low urgency. In another example, the scale may be a numeric range (e.g., 1-5, 1-10, etc.) and the urgency level may be displayed as a value in the numeric range. As another example, the urgency level may be displayed as a monetary cost to the merchant if the merchant does not perform any actions to address the inventory level or a monetary gain to the merchant if the merchant does perform actions to address the inventory level.

In one or more embodiments of the invention, the inventory reorder preferences (132) stores the merchant's preferences for reordering inventory items. For example, the inventory reorder preferences (132) may include whether the merchant orders the inventory via the inventory management application, how to update inventory when it is received, and any other data for reordering inventory items.

Continuing with the data repository (102), in one or more embodiments of the invention, supplier data (114) includes information about each of the merchant's suppliers. For example, supplier data may include an address, contact person, pricing schedule, ordering requirements, contract terms with the supplier, payment information for paying the supplier, or any other data about the supplier.

In one or more embodiments of the invention, customer data (116) provides information about the merchant's customers. For example, customer data (116) for a particular customer may include address information, whether the customer has a special discount, preferences of the customer, purchase history of the customer, birthday of the customer, or any other information about the customer.

As discussed above, the merchant inventory management system (100) may include point of sale hardware (104). Point of sale hardware (104) includes devices used for the sale of goods. Specifically, point of sale hardware (104) includes functionality to process purchases, scan product codes for the identification of products purchased or added to inventory, and perform other functions related to the sale of goods. For example, point of sale hardware (104) may include a card reader (e.g., credit/debit card reader), a receipt printer, a bar code reader, an inventory scanner (e.g., RFID, Bar Code, Quick Response (QR) codes/matrix barcodes, etc), a pin pad, computer system(s), and other devices. Further, at least one or all components of the point of sale hardware may be located on a mobile device. For example, the mobile device may correspond to a mobile handset.

The point of sale hardware (104) and the data repository (102) are connected to an inventory management application (106) in accordance with one or more embodiments of the invention. The inventory management application (106) includes functionality to update the data repository (102) when items are purchased or sold, assist in the ordering of inventory items, perform accounting functions, and track customers and suppliers. In one or more embodiments of the invention, the inventory management application (106) includes functionality to track the expiration date of inventory items, forecast the number of units of each of the inventory items at the expiration date, and provide a notification when the forecasted number of units is greater than the pre-defined threshold. The inventory management application (106) may further include functionality to transfer data regarding expiring inventory items to the merchant transaction system.

In one or more embodiments of the invention, the inventory management application (106) includes functionality to update and receive updates when inventory items are sold by the merchant via the point of sale hardware (104) or by the merchant transaction system. Specifically, the inventory management application (106) includes functionality to maintain coherency with the merchant transaction system regarding the number of units sold. Specifically, when a unit of an inventory item is sold via the inventory management application that is also for sale via the merchant transaction system, the inventory management application includes functionality to send an update to the merchant transaction system. Conversely, when a unit of an inventory item is sold via the merchant transaction system, the inventory management application includes functionality to receive an update from the merchant transaction system and update the merchant's data repository (102).

In one or more embodiments of the invention, the inventory management application (106) includes functionality to track when an inventory item should be reordered. In one or more embodiments of the invention, the inventory management application includes functionality to communicate an identifier and a quantity for reorder to the merchant transaction system via the network (108). Thus, not only may a merchant use the inventory management application (106) and merchant transaction system to sale inventory items, the merchant may also use the aforementioned components to purchase inventory items. Further, the inventory management application (106) may include functionality to assist the merchant to reorder inventory items from the merchant's suppliers.

In one or more embodiments of the invention, the inventory management application includes a mobile interface for use on mobile devices, a web interface, a local graphical user interface, and/or application programming interface for communication with the merchant transaction system.

Although not shown in FIG. 1A, the merchant inventory management system (100) may be geographically located in whole or in part at the merchant's physical location and/or at a location remote from the merchant's physical location. For example, the data repository (102) and/or inventory management application (106) may be accessible via a network (108) by multiple merchants. Each of the merchants may have an individual account that protects the merchant's data. For example, the inventory management application (106) and/or the data repository (102) may be located at the same geographic site as the merchant transaction system.

Further, although not shown in FIG. 1A, the merchant inventory management system (100) may be at least a part of a point of sale system. For example, the merchant may have one or more computer systems that form the merchant's point of sale system. The one or more computer systems may include the point of sale hardware (104), have storage devices for storing the data repository (102), and include functionality to execute the inventory management application (106). Alternatively, the data repository (102) and the inventory management application (106) may be a separate system from the merchant's point of sale system. For example, the data repository (102) and the inventory management application (106) may be located and execute within a separate physical or virtual computer system from the merchant's point of sale system.

FIG. 1B shows a merchant transaction system (150) in accordance with one or more embodiments of the invention. As shown in FIG. 1B, the merchant transaction system (150) may be connected to merchant inventory management systems (e.g., merchant inventory management system A (152A), merchant inventory management system B (152B)), a non-profit organization (154), and general consumers (156) in accordance with one or more embodiments of the invention. The connection may be in whole or in part via the network (108). As an alternative, as discussed above with respect to FIG. 1A, all or part of the merchant inventory management system (e.g., merchant inventory management system A (152A), merchant inventory management system B (152B)) may be directly connected to the merchant transaction system (150) rather than via a network (108).

In one or more embodiments of the invention, a non-profit organization (154) corresponds to any tax-exempt organization. Moreover, donations to the organization are tax exempt. In general, non-profit organization is deemed a buyer or potential buyer when the non-profit organization receives or has the option to acquire an item by purchase or donation.

Further, the general consumer (156) corresponds to any user, group, or legal entity. Specifically, the general consumer is a non-restricted group of users. Thus, whereas non-profit organizations and merchants are restricted to a particular type or status of business entity, the general consumer may potentially include anyone. Therefore, the general consumer (156) may not have any credentials with regards to buying and selling goods. Because the general consumer (156) may not be a reseller, the general consumer is not required to have an inventory management system or a merchant's account at the merchant transaction system (150).

In one or more embodiments of the invention, the merchant transaction system (150) is a mechanism for merchants to sell or otherwise dispose of excess inventory. Specifically, in one or more embodiments of the invention, only merchants may post inventory items for sale to the merchant transaction system (150). Further, the merchant transaction system (150) is configured to offer the excess inventory items only to those potential buyers specified by the merchant. Thus, a merchant may offer an inventory item for sale on the merchant transaction system (150) without offering the inventory item to the merchant's customers or competitors. In one or more embodiments of the invention, the merchant transaction system (150) includes a merchant transaction application (158) and a data repository (160).

In one or more embodiments of the invention, the merchant transaction application (158) includes functionality to perform the functions of the merchant transaction system (150). For example, the merchant transaction application (158) may include functionality to match merchant's excess inventory to the appropriate buyer network. Moreover, the merchant transaction application (158) may include functionality to match the excess inventory of a particular merchant to a buyer in the buyer network desiring the type of inventory item in the excess inventory. The merchant transaction application (158) may include various interfaces. For example, the merchant transaction application (158) may include a mobile interface for communication with a small mobile device, a web interface for communication with a personal computer via the Internet, an application programming interface, and/or a local graphical user interface that integrates with the inventory management application. Further, the inventory management application and the merchant transaction application (158) may be two components of the same application.

Continuing with FIG. 1B, the merchant transaction system (150) includes a data repository (160) in accordance with one or more embodiments of the invention. The data repository (160) in the merchant transaction system may be the same data repository, with the additional data, as in the merchant inventory management system (e.g., merchant inventory management system A (152A), merchant inventory management system B (152B)) (discussed above and in FIG. 1A). The data repository (160) may alternatively be a different data repository.

In one or more embodiments of the invention, the data repository (160) includes merchant accounts (e.g., merchant A account (162A), merchant B account (162B)). Additionally, although not required, the data repository (160) may include one or more non-profit organization accounts (164) and one or more general consumer accounts (166). Although not shown in FIG. 1B, each of the accounts may include authentication and authorization credentials. Each of the type of accounts is discussed below.

In general, a merchant account (e.g., merchant A account (162A), merchant B account (162B)) stores information for selling and/or buying inventory. For example purposes, FIG. 1B shows contents of merchant account A (162A). Specifically, while FIG. 1B shows only information about merchant account A (162A), merchant B account (162B) and any other merchant accounts may also store similar types of content. As shown in FIG. 1B, the merchant A account (162A) may include an excess inventory item record (168), a desired inventory item record (170), and account settings (172). Although only a single record of each type is shown, a separate record may exist for each desired inventory item and each excess inventory item.

In one or more embodiments of the invention, an excess inventory item record (168) is a record about excess inventory that the merchant wants to sell via the merchant transaction system (150). The excess inventory item record (168) includes a description of the inventory item (174), number of units offered (176), a buyer network identifier (178), and a price (180).

The description of the inventory item (174) may include a similar description as discussed above with regards to the inventory item record in FIG. 1A. Specifically, the description of the inventory item record (174) provides an identifier for the inventory item. For example, the description (174) may include a textual phrase describing the inventory item, a stock-keeping unit (SKU) identifier or other product code, attributes of the inventory item (e.g., size, place of origin, manufacturer, supplier of the inventory item), and/or any other descriptive information about the inventory item. Further, the description of the inventory item may include the universal unique identifier that is unique for the inventory item and used for the inventory item across all merchants.

In one or more embodiments of the invention, the number of units offered (176) is the number of units that the merchant is offering for sale via the merchant transaction system (150). In one or more embodiments of the invention, the number of units offered (176) may not reflect the total number of units that the merchant has for sale (e.g., available at the physical location of the merchant), but rather is the difference between the forecasted number at the expiration date of the inventory item and the threshold number at the expiration date. In other words, the number of units offered (176) is the forecasted excess that the merchant would have at the expiration date. The number of units offered may be dynamically updated as the forecast is updated. The dynamic updating may or may not require the merchant's approval at the time of update.

For the following two examples, consider the scenario in which two weeks prior to the expiration date, the inventory management application forecasts that the number of units at the expiration date exceeds the threshold by 70 units. In the examples, the number of units offered may be initially set to 70. In the first example, if the merchant suddenly sells 30 units two days later via the merchant's physical store and no units are sold via the merchant transaction system, a revised forecast generated two days later may forecast only 40 units of excess. Thus, the number of units offered may be dynamically adjusted to 40 units to account for the revised forecast.

Conversely, in the second example, consider the scenario that after initially forecasting 70 units of excess, the merchant fails to sell any units via the merchant's physical store or the merchant transaction system. In the example, the revised forecast generated a week later may increase to 100 units to account for additional units at the merchant's store that the merchant most likely will not sell. In the second example, the number of units in the excess inventory item record may dynamically increase to 100 units.

Continuing with the excess inventory item record (168), the buyer network identifier (178) identifies which buyer network to offer the inventory item. In particular, the buyer network corresponds to the group of potential buyers that the merchant is offering the inventory. The buyer network identifier may include required attributes of potential buyers in the buyer network. Specifically, the required attributes may include one or more geographic limitations for store(s) (e.g., one or more geographic regions of potential buyers, minimum distance between the merchant's store and the potential buyer's store, maximum distance between the merchant's store and the potential buyer's store), type of potential buyer (e.g., general consumer, merchant, non-profit organization), class of goods sold if potential buyers include merchants (e.g., high end, outlet, low end), and/or other attributes that may be used to specify and/or limit the potential buyers.

In one or more embodiments of the invention, the buyer network is defined by the merchant. For example, a merchant not wanting to compete with their physical store may set the buyer network identifier to require that only merchants are potential buyers. Thus, the merchant's normal customers are excluded as buyers. As another example, the merchant may define the buyer network to require that the potential buyers are merchants that have stores geographically located between a minimum radius and a maximum radius from the merchant's store in order to prevent direct competition as potential buyers and to decrease amount spent on shipping and reduce delay to ship. In the example, a merchant with a store in Santa Clara, Calif. may exclude all merchants located in Santa Clara, Calif. and all merchants located farther than Oakland, Calif.

Thus, the buyer network allows the merchant to define how restrictive the set of potential buyers are for a particular inventory item. For example, a merchant may define a restrictive buyer network by selecting particular attributes that a potential buyer must have to qualify as a potential buyer. A merchant may set a less restrictive buyer network by excluding one or more requirements of potential buyers.

Further, similar to the number of units, the buyer network identifier (178) may be set to change over time. Specifically, a first buyer network may be used initially, then replaced with a second buyer network, which may be replaced with another buyer network, and so forth as the expiration date approaches. Thus, the excess inventory item record (168) may include multiple buyer networks, each associated with a time frame. Different mechanisms may be used to store the dynamic change in the buyer network. For example, each restrictive attribute in the buyer network identifier may be specified with field defining whether and when to remove the restrictive attribute. Further, additional attributes may be defined with whether and when to add the additional attributes.

In another mechanism, the excess inventory item record stores multiple buyer network identifiers. Each buyer network identifier has a separate set of attributes of potential buyers and a defined time for when to sell on the corresponding buyer network. For example, consider the scenario in which buyer network identifier X, buyer network identifier Y, and buyer network identifier Z are in the excess inventory item record. Buyer network identifier X may specify attributes for buyer network X and specify to use buyer network X initially. Buyer network identifier Y may specify attributes for buyer network Y and specify to use buyer network Y starting two weeks prior to the expiration date. Buyer network identifier Z may specify attributes for buyer network Z and specify to use buyer network Z starting one week prior to the expiration date.

Continuing with the excess inventory item record, the price (180) defines the price that the merchant is offering the excess inventory for sale. Because the buyer network may exclude the merchant's customers, the merchant may offer the excess inventory at a lower price than what the merchant is offering to the merchant's customers. In other words, the merchant may sell the merchant's excess inventory at price to get rid of the excess without damaging the merchant's expected profits from selling the expected number of units. Similar to the buyer network, the price may also be dynamically updated. For example, as the inventory item is closer to the expiration date, the price (180) may be reduced. Thus, the excess inventory item record may have multiple prices or price reductions defined and the time period for the corresponding price or the price reduction. Alternatively or additionally, multiple increasing prices or price increases may be defined. For example, the multiple increasing prices may be defined according to different amounts of excess inventory at different times.

In one or more embodiments of the invention, a desired inventory item record (170) defines which items are desired for purchase. The desired inventory item record (170) includes a description of the inventory item (182) and the number of units desired (184). The description of the inventory item (182) may include similar type of information as in an excess inventory item record. For example, the description of the inventory item may include the universal unique identifier that is unique for the inventory item and used for the inventory item across all merchants. The description of the inventory item (182) may include additional information without departing from the scope of the invention. The number of units desired (184) specifies the number of units that the merchant wants to purchase.

In one or more embodiments of the invention, the account settings (172) include information about the owner of the account and the default settings. For example, account settings (172) may specify a merchant identifier (e.g., an identifier used by a financial institution to process credit or debit card transactions for the merchant), authorization information (e.g., a user name and password), geographic location information (e.g., location of the merchant's physical stores), information about merchant's internet stores, contact information for the merchant, and default settings for the buyer network. The account settings may also specify default prices for excess inventory (e.g., at the purchase price paid by the merchant, two percent over the purchase price paid by the merchant, etc.).

Continuing with the data repository (160), in one or more embodiments of the invention, non-profit organization account (164) is a type of account defined for a non-profit organization (154). Specifically, the non-profit organization account (164) only allows access to view inventory items for sale to non-profit organizations (154). Thus, a non-profit organization account (164) is not associated with permissions that allow a non-profit organization to view items offered for sale only to merchants. The non-profit organization account (164) includes information about the non-profit organization (154). For example, the non-profit organization account (164) may include account settings that specify authorization information (e.g., a user name and password), geographic location information for donating items, contact information for the non-profit organization (154), causes supported by the non-profit organization (154), and a tax number for donating to the non-profit organization (154). The non-profit organization account (164) may also include a desired inventory item record similar to the merchant's desired inventory item record (170).

In one or more embodiments of the invention, the general consumer account (166) is a type of account defined for a general consumer (156). Specifically, in contrast to the merchant account (e.g., merchant A account (162A), merchant B account (162B)) and the non-profit organization account (164), any user may have a general consumer account (166) in accordance with one or more embodiments of the invention. The general consumer account (166) only allows access to view inventory items for sale to general consumers (156). Thus, a general consumer account (166) is not associated with permissions to view items offered for sale on only to merchants or offered for sale to non-profit organizations (154). The general consumer account (166) may include information about the corresponding general consumer (156). For example, the general consumer account (166) may include account settings that specify authorization information (e.g., a user name and password), payment information, and contact information. The general consumer account (166) may also include a desired inventory item record similar to the merchant's desired inventory item record (170).

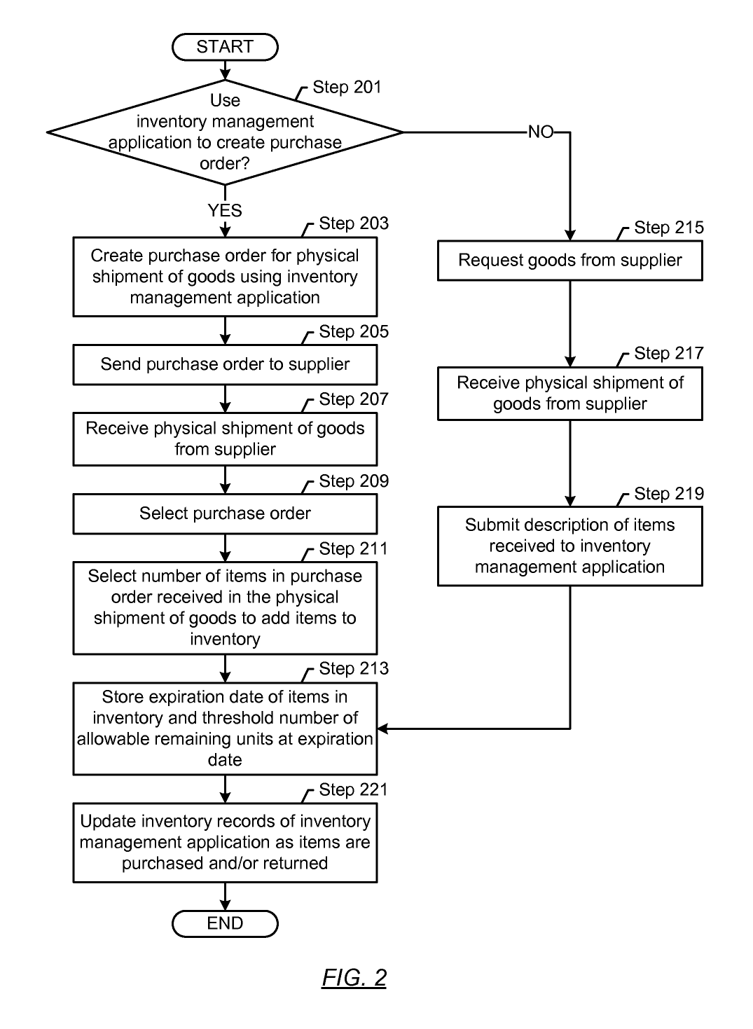

FIGS. 2-6 show flowcharts in accordance with one or more embodiments of the invention. While the various steps in this flowchart are presented and described sequentially, one of ordinary skill will appreciate that some or all of the steps may be executed in different orders, may be combined or omitted, and some or all of the steps may be executed in parallel.

Furthermore, the steps may be performed actively or passively. For example, some steps may be performed using polling or be interrupt driven in accordance with one or more embodiments of the invention. By way of an example, determination steps may not require a processor to process an instruction unless an interrupt or notification is received to signify that condition exists in accordance with one or more embodiments of the invention. As another example, determination steps may be performed by performing a test, such as checking a data value to test whether the value is consistent with the tested condition in accordance with one or more embodiments of the invention. As another example, the determination step represents a condition that defines whether one set or another set of steps are performed.

FIG. 2 shows a flowchart for a merchant to add an inventory to the merchant's inventory management system in accordance with one or more embodiments of the invention. In Step 201, a determination is made whether to use the inventory management application to create a purchase order. Specifically, in one or more embodiments of the invention, the merchant may use the inventory management application to create and track the purchase order. Determining whether to use the inventory management application may be based on whether the inventory management application has the required functionality and whether the supplier of the merchant accepts purchase orders via the inventory management application.

In Step 203, if a determination is made to use the inventory management application, then a purchase order is created for a physical shipment of goods using the inventory management application. Specifically, the inventory management application may guide the merchant through a series of steps for creating the purchase order. The guide may include asking the merchant for the universal unique identifier or other description of the inventory item, a number of inventory items, due date for the inventory, and other terms for purchase. If the merchant is only restocking existing inventory, then the inventory management application may allow the merchant to copy a previous purchase order to generate a new purchase order.

In Step 205, the purchase order is sent to the supplier in one or more embodiments of the invention. The purchase order may be sent to the supplier directly from the inventory management application. Alternatively, the merchant may send the purchase order to the supplier.

In Step 207, the merchant receives a physical shipment of goods from the supplier. The physical shipment may include all or part of the goods requested in the purchase order.

In one or more embodiments of the invention, if the merchant uses the inventory management application to create the purchase order, then the merchant may update the inventory using the inventory management application. Specifically, in Step 209, the merchant may select the purchase order that orders the goods in the physical shipment from a list of purchase orders. In Step 211, the merchant may select the number of each item in the purchase order that is received in the physical shipment of goods. Rather than selecting the purchase order and inventory items, the merchant may scan the goods received in the physical shipment using, for example, a bar code scanner, a radio frequency identifier scanner, or any other device for detecting identifiers of each inventory item. The inventory management application may use the scanned identifiers to update the purchase order to reflect which goods were received and update the merchants inventory with the number of units of each inventory item received.

In one or more embodiments of the invention, in Step 213, the expiration date of items in the inventory and the threshold of allowable remaining units at the expiration date are stored for each inventory item received. In one or more embodiments of the invention, the merchant may submit the information to the inventory management application.

Rather than the merchant submitting the information, the inventory management application may automatically store the information. For example, the inventory management application may be pre-configured with a duration of time from when a good is received until the good expires. By way of a concrete example, the inventory management application may be pre-configured to set the expiration date of bananas as two weeks after the bananas are received, and the expiration date of milk as three weeks after the milk is received. By way of another concrete example, the inventory management application may be configured to set the expiration date of articles of spring clothing as May 31 of the year in which the spring clothing is received. The threshold number of units may be similarly pre-configured in the inventory management application. Pre-configuration may be performed by the merchant, by the vendor of the inventory management application, or by another entity.

Alternatively, the expiration date may be set by the manufacturer of the inventory item and provided to the merchant. In such a scenario, the inventory management application may obtain the expiration date from an invoice, the goods, or another source of the expiration date.

Returning to Step 201, if the inventory management application is not used to create the purchase order, then the merchant may request goods from the supplier in Step 215. For example, the merchant may enter the request in a supplier's form for a purchase order or the merchant's form. The merchant may have a pre-defined agreement with the supplier for purchasing goods from the supplier. In such a scenario, the merchant may request the goods according to the predefined agreement.

In Step 217, the merchant receives a physical shipment of goods in accordance with one or more embodiments of the invention. In Step 219, the merchant submits, to the inventory management application, a description of items received. The merchant may submit a detailed description or may submit enough information for the inventory management application to identify the new inventory item. The merchant may submit the information by scanning the inventory (as discussed above) in accordance with one or more embodiments of the invention. Further, as discussed above, in Step 213, the expiration date and the threshold number of allowable remaining units are stored.

Although not discussed above, rather than the merchant obtaining inventory items from a supplier, the merchant may obtain inventory items from the merchant transaction system. When the merchant accesses the merchant transaction system, the merchant transaction system identifies the merchant and presents the merchant with offers from other merchants. The merchant may peruse the offers, search for specific inventory items by description, or create a desired inventory item record for desired inventory. If the merchant creates a desired inventory item record, then the merchant transaction system may send a notification to the merchant when the desired inventory item is being offered for sale to a buyer network of which the merchant is a member. The merchant may view details about offers in the merchant transaction system and determine whether to purchase an inventory item. If the merchant decides to purchase the inventory item via the merchant transaction system, then the merchant purchases the inventory item via the merchant transaction system and receives the physical shipment of the inventory item in accordance with one or more embodiments of the invention. Based on the receipt of the inventory item, the inventory management application updates the merchant's inventory records. Updating the inventory records with new inventory items may be performed as discussed above.

Continuing with FIG. 2, after the physical shipment of goods is received and information stored in the inventory management application about the inventory items received in the physical shipment of goods, the inventory management application has current inventory records. In Step 221, inventory records are updated as one or more units of the inventory item are purchased, returned, stolen, lost, destroyed, spoiled, and/or otherwise disposed. The inventory records may be manually or automatically updated. For example, point of sale hardware may receive identifying information (e.g., by scanning a bar code, reading a RFID tag, receiving a universal product code from keypad input) at the point of sale. The point of sale hardware may send the identifying information to the inventory management application at checkout. The inventory management application automatically updates the inventory to reflect the number of units of the items that were sold. A similar set of steps may be performed when an inventory item is returned. However, in a return, the merchant may include information as to whether the units of inventory item should be returned to the supplier, sold at a discount, or returned to inventory. The inventory management application appropriately adjusts the inventory item records.

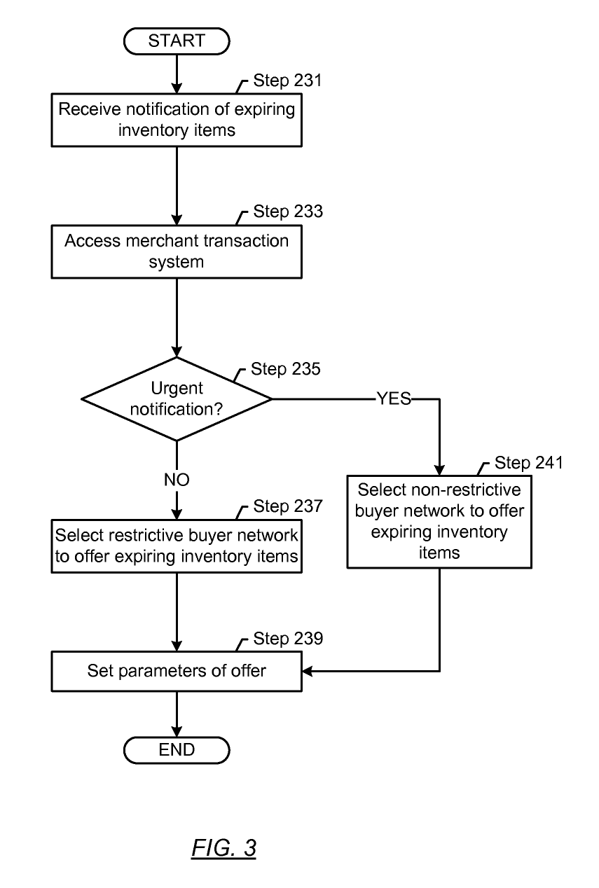

FIG. 3 shows a flowchart for a merchant to address a notification of an expiring inventory item in accordance with one or more embodiments of the invention. Specifically, the inventory management application may issue notifications to the merchant of inventory items that are expiring. FIG. 3 shows a flowchart for the merchant in one or more embodiments of the invention.

In Step 231, the merchant receives a notification of expiring inventory items. The notification is received according to the merchant's notification preferences. Thus, the notification is in accordance with the time, mode of communication, and manner defined by the merchant in one or more embodiments of the invention. In one or more embodiments of the invention, the contents of the notification may include a partial or complete description of the inventory item, an urgency level for the notification, the monetary consequence to the merchant of not selling the inventory item, the expiration date, number of excess units of inventory, and/or a reference to the merchant transaction system. When the merchant views the notification, the merchant is able to identify how urgent the notification is and determine what to do with the notification. If the merchant decides to sell the excess inventory via the merchant transaction system, then the notification includes the reference to the merchant transaction system that guides the merchant through posting the excess inventory to specified merchant networks.

Continuing with FIG. 3, in Step 233, the merchant accesses the merchant transaction system in one or more embodiments of the invention. Specifically, the merchant may select the reference to the merchant transaction system. Alternatively, the inventory management application may provide the interface to the merchant transaction system.

In Step 235, the merchant may determine whether the notification is an urgent notification. Specifically, based on the urgency level of the notification, the merchant may decide how to handle excess inventory.

If the notification level is not urgent, then the merchant may decide to ignore the notification or sell the inventory item via the merchant transaction system on a restrictive network. If the merchant decides to sell the inventory item on the merchant transaction system, the merchant accesses the merchant transaction system (not shown). The merchant may access the merchant transaction system by submitting a uniform resource locator (URL) address of the merchant transaction system, selecting a menu item in the inventory management application that links to the merchant transaction system, selecting a reference in the notification, and/or performing another action to access the merchant transaction system. In one or more embodiments of the invention, the reference in the notification may connect the merchant to a start page of the merchant transaction system, to a list of expired inventory items in the merchant transaction system, to a page for selling the specific inventory item in the merchant transaction system, or to another location at the merchant transaction system.

In one or more embodiments of the invention, the merchant may select a restrictive buyer network to offer expiring inventory items in Step 237. For example, the merchant may specify that buyer network is only merchants selling specific class of goods in a limited geographic region. The merchant may alternatively specify that the buyer network is only particular merchants. The merchant may identify the particular merchants by a unique identifier, such as contact information, address, and name of the particular merchant. The merchant may have alternative or additional restrictions on the buyer network for selling the expiring inventory item.

In Step 239, the merchant sets the parameters of the offer on the restrictive buyer network. For example, the merchant may set a price at slightly below the price that merchant is offering to the merchant's customers. The merchant may also specify shipping terms, such as the method of shipping and whether the merchant or the buyer will pay for the shipping. Further, in one or more embodiments of the invention, the merchant specifies the number of units of the inventory item to sell in the offer. In one or more embodiments of the invention, the merchant transaction system is updated by the inventory management application with the description of the inventory item and the forecasted number of excess units. Alternatively or additionally, the merchant transaction system may be updated with the total number of units that the merchant has in inventory. Thus, when the merchant offers an item for sale via the merchant transaction system, the merchant transaction system is able to guide the merchant by providing the merchant with the description, the number of excess units and/or the total number of units.

Returning to Step 235, if the notification is urgent or more urgent, then the merchant may decide to use a non-restrictive buyer network. For example, the merchant may select a non-restrictive buyer network to offer the expiring inventory items in Step 241. For example, if the merchant determines that the excess inventory should be sold immediately to avoid a loss, the merchant may select the general consumer as the buyer network. Alternatively or additionally, the merchant may select non-profit organizations as the buyer network in order to donate the excess inventory item. Alternatively or additionally, the merchant may adjust the required attributes of potential buyers in an existing buyer network or sell the inventory item below the merchant's purchase price (e.g., the amount that the merchant paid the supplier for the inventory item). Further, the merchant may select parameters of the offer in Step 239. When the notification is urgent, the merchant may decide to lower the price or change other terms of the offer to make purchasing the excess inventory more appealing.

Although not shown in FIG. 3, rather than changing the buyer network as the urgency level increases, the merchant may decide to only adjust the price. Further, although not shown in FIG. 3, the merchant may set the merchant transaction system with multiple buyer networks and sets of parameters for selling the expiring inventory item. The merchant may pre-configure the merchant transaction system with the triggering event to use each buyer network and set of parameters. The triggering event may be time based, based on the potential consequence to the merchant, urgency level, etc. Thus, the merchant does not update the buyer network as the expiration date of the inventory item approaches. Rather the merchant transaction system automatically updates the expiring inventory item. Further, rather than the merchant updating the merchant transaction system for offering individual inventory items for sale via the merchant transaction system, the merchant may pre-configure the merchant transaction system with default parameters for when to offer excess inventory items for sale via the merchant transaction system. Thus, the merchant transaction system may operate with the inventory management application to automatically offer excess inventory for sale without merchant intervention.

In general, in one or more embodiments of the invention, the inventory management application provides the merchant with the information to make an informed businesses decision about how to handle excess inventory, and the merchant transaction system provides the merchant with highly configurable parameters to specify how the merchant will sell the excess inventory via the merchant transaction system. For example, the merchant may tweak the buyer network, the price, or other parameters of the offer as the urgency to sell the inventory or the potential consequence to the merchant of not selling the excess inventory increases. Thus, not only may a merchant be able to make an informed business decision, but the merchant can act on the business decision in one or more embodiments of the invention.

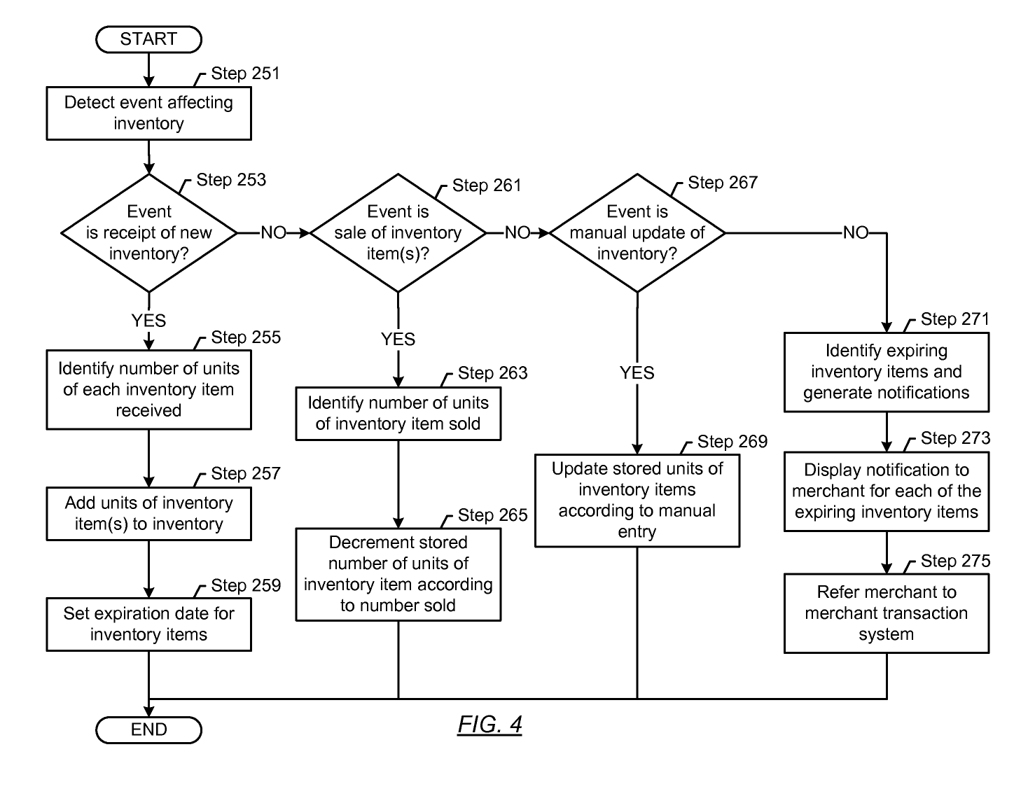

FIG. 4 shows a flowchart for the inventory management application to track inventory in accordance with one or more embodiments of the invention. In Step 251, the inventory management application detects an event affecting the inventory in one or more embodiments of the invention. In one or more embodiments of the invention, the event affecting the inventory may be the receipt of new inventory, sale or return of inventory items, manual update of inventory items, or check for expiring inventory items. Event detection for receipt of new inventory, sales and return, or manual update may be triggered by the merchant and the merchant's customers. Checking for expiring inventory items may be continually or periodically performed. For example, an event to identify expiring inventory items may be based on the expiration of the current period to check for expiring inventory items. For example, the inventory management application may perform a check to determine whether and which expiring inventory items exist once or twice a day, week, or at another period.

Continuing with FIG. 4, in Step 253, a determination is made whether the event is receipt of new inventory. If the event is receipt of new inventory, then the inventory management application identifies the number of units of each inventory item received in Step 255. For example, the inventory management application may receive manual input of the number of units and description. As another example, the inventory management application may receive the information from the point of sale hardware.

Additionally, although not shown in FIG. 4, if the inventory management application was not used to create the purchase order, then the inventory management application may prompt the user for purchase information to obtain the price that the merchant paid for the inventory. Thus, the amount that the merchant paid for the inventory may reflect the merchant's cost basis (e.g., a tax basis) in the inventory.

In Step 257, the inventory management application adds the units of the inventory item(s) to inventory. Specifically, the inventory management application creates a record for the inventory item(s). If a record exists, then the inventory management application determines whether to update the existing record. The existing record is updated when the received inventory items are the same as the existing inventory items. For example, if the received inventory items have a different expiration date, then a new record may be created. In another example, if the received inventory items are a restocking of a child's toy, or an electronic device, then the existing record may be updated.

In Step 259, the expiration date for the inventory item(s) is stored. The expiration date may be obtained from an owner or a data repository that associates types of goods with the duration of time in which the goods are within the expiration date. Further, the threshold number of units of the inventory items may be stored. As with the expiration date, the threshold number may be obtained from the owner or the data repository.

Returning to Step 253, if the event is not the receipt of new inventory, then a determination is made whether the event is the sale of existing inventory in Step 261. For example, point of sale hardware may send to the inventory management application information about units of inventory items sold. The information may include the number of units and an identifier of the inventory item. Accordingly, if the event is a sale of an inventory item, the inventory management application identifies the number of units of inventory item sold in Step 263. In Step 265, the inventory management application decrements the stored number of units of the inventory item according to the number sold. Thus, the merchant's inventory records are current.

Although not shown in FIG. 4, a similar method may be performed when units are returned. For example, the inventory management application may update the inventory records according to the condition of the inventory item returned in one or more embodiments of the invention. If the condition is new, then the inventory management application increments the inventory record corresponding to the inventory item. If the condition is saleable but not new, then the inventory management application may create a new inventory record for the particular unit. If the condition is unsalable, then the inventory management application may log the return of an unsalable inventory item in the data repository. The operations performed by the inventory management application on a return may be dependent on the merchant and any configuration by the merchant in one or more embodiments of the invention.

Continuing with FIG. 4, the merchant may occasionally or periodically perform manual inventory accounting. Specifically, the merchant may decide to periodically count each unit of each inventory item to ensure that the merchant's records are accurate. For example, if a thief steals a unit of an inventory item and bypasses point of sale hardware, the inventory management application may not decrement the inventory record based on the loss of the item. Accordingly, the inventory management application may occasionally receive a manual update of inventory.

In Step 267, a determination is made whether the inventory management application receives a manual update of an inventory record. If the merchant receives the manual update, then the stored units of the inventory items are updated according to the manual entry in Step 269. For example, the inventory management application may present the merchant with a selection tool to select the inventory item and a number entry tool to enter the number of units of the inventory item.

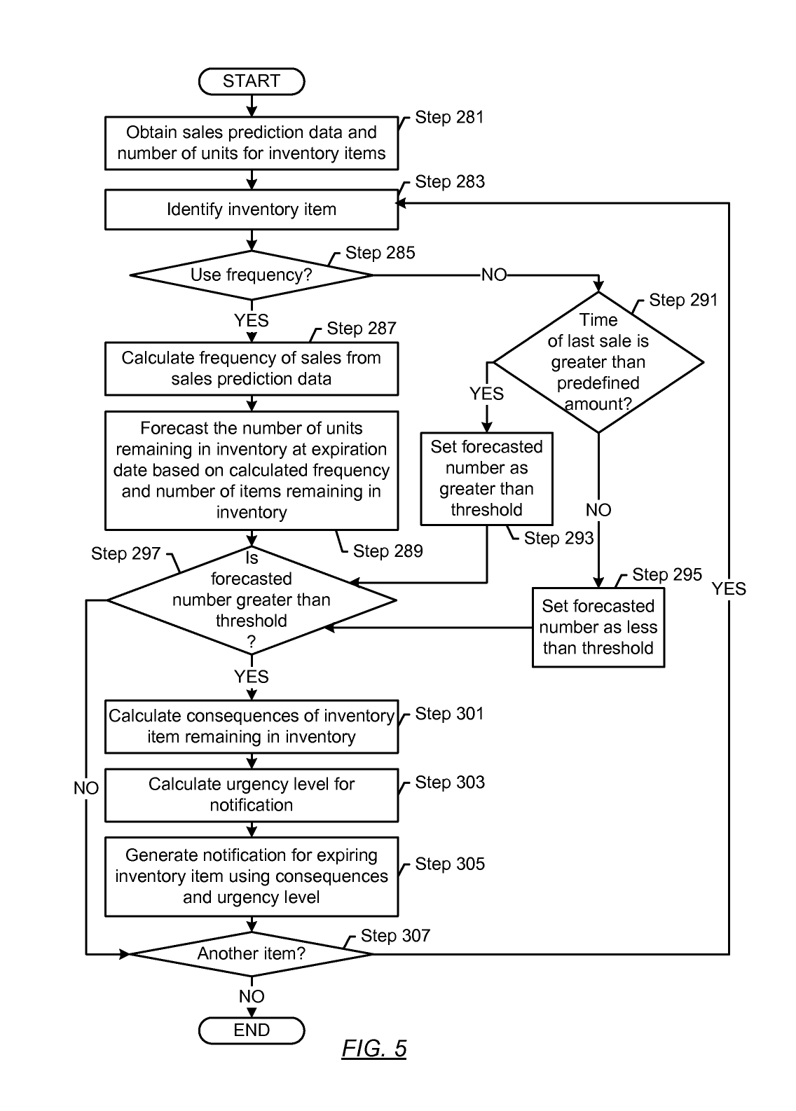

If the event is not for manual update, then the event may be to check for expiring inventory items in one or more embodiments of the invention. If the event is to check for expiring inventory items, then expiring inventory items are identified and notifications are generated in Step 271. Identifying expiring inventory items and generating notifications is discussed below in FIG. 5.

Continuing with FIG. 4, in Step 273, notifications are displayed to the merchant for each of the expiring inventory items in one or more embodiments of the invention. For example, notifications may be grouped into a single flat or hierarchical list of expiring inventory items or separated according to the merchant's notification preferences.

After viewing the notifications, the merchant may select a notification to sell the expiring inventory item on the merchant transaction system. In Step 275, the merchant is referred to the merchant transaction system to sell the expiring inventory item. Before, during, or after referring the merchant to the merchant transaction system, the inventory management application may update the merchant transaction system with the expiring inventory items. Specifically, the inventory management application sends information about the expiring inventory items to the merchant transaction system.

Returning to identifying expiring inventory items, FIG. 5 shows a flowchart for the inventory management application to identify expiring inventory items and generate a notification in accordance with one or more embodiments of the invention.

In Step 281, sales prediction data and number of units for each item in inventory is obtained. The sales prediction data may be obtained for all or a subset of inventory items. For example, the subset of inventory items may be those that have an expiration date within a pre-defined period of time (e.g., within the next three weeks, within the next month, etc.), or have a high cost basis to the merchant. As another example, at the end of a tax year, the sales prediction data for all inventory items may be obtained. The sales prediction data obtained at the end of the tax year may be used to identify expiring inventory items and to capture any beneficial tax consequences of selling or otherwise disposing of the expiring inventory items.

As another example, the subset of inventory items may exclude inventory items in which a notification was recently issued. For example, rather than constantly notifying a merchant, notifications for a particular inventory item may be issued only at specified rate. For non-perishable inventory items, the rate may be constant in one or more embodiments of the invention. For perishable inventory items, the rate may increase as the expiration date approaches. Thus, if a notification was recently issued and if a new notification is not due based on the rate, the inventory management application may exclude the inventory item from the check to determine whether to issue another notification. In such a scenario, the subset of inventory items for which sales prediction data is obtained may exclude the inventory item for which a notification was recently issued.

In Step 283, an inventory item is identified. Specifically, an inventory item is selected to determine whether the inventory item is expiring.

In Step 285, a determination is made whether to use frequency to forecast the number of units of the inventory item at the expiration date in one or more embodiments of the invention. If a determination is made to use frequency, then the inventory management application calculates the frequency of sales from the sales prediction data in Step 287. Frequency may be calculated by identifying a period of time over which to calculate the frequency and obtaining, from the sales prediction data, the number of units sold during the period of time. The number of units sold divided by the length of time in the period is calculated to obtain the frequency. Additionally or alternatively, in one or more embodiments of the invention, frequency may be calculated from historical sales trends for similar merchants and items documented and shared through the merchant transaction system. Additionally or alternatively, in one or more embodiments of the invention, the forecasted number of units may be calculated based on any set of aggregate sales trends from another source.

In Step 289, the inventory management application forecasts the number of units remaining in inventory at the expiration date based on the calculated frequency and the number of units remaining in inventory. Different methods may be used to forecast the number of units using calculated frequency. Below are two methods for forecasting the number of units at the expiration date. Other methods may be used to forecast the number of units at the expiration date using frequency without departing from the scope of the invention.

In a first method, the forecast may be based on the assumption that the frequency of sales remains constant. Under the first method, the amount of time until the expiration date is multiplied by the frequency to obtain the expected number of units sold by the expiration date. The expected number of units sold is subtracted from the number of units in inventory. If the result is a positive number, then the result is the forecasted number of units in inventory at the expiration date. If the result is a negative, then the result is the forecasted amount of demand that the merchant is unable to fulfill.

In a second method, the forecast may be based on an assumption that changes in frequency of sales occur and the amount of change in frequency is constant. For example, as holiday season approaches, the frequency at which toys are sold may increase. In another example, for new electronic devices, the frequency at which the electronic devices are sold may decrease over time. In the second method, the change in frequency is used to extrapolate the expected future frequencies at which the inventory item is sold. The expected future frequencies are used to calculate the number of units sold. Specifically, for each expected future frequency the amount of time in which the expected future frequency is to be used is multiplied by the expected future frequency to obtain the expected number of units sold by the expiration date. As with the first method, the expected number of units sold is subtracted from the number of units in inventory. If the result is a positive number, then the result is the forecasted number of units in inventory at the expiration date. If the result is a negative, then the result is the forecasted amount of demand that the merchant is unable to fulfill.

Returning to Step 285 in FIG. 5, if a determination is made not to use frequency, then the time of last sale may be used. If a determination is made to use the time of last sale, then a determination is made whether the time of the last sale is greater than the predefined amount of time in Step 291. Specifically, the inventory management application may assume that if an inventory item has not sold in the past predefined amount of time, then, at most, only a minimal number of additional units will be sold by the expiration date. The predefined amount of time may be set by the merchant for the inventory item or pre-configured in the inventory management application.

If the time of the last sale is greater than the predefined amount of time and the number of units in inventory are more than the threshold number of units, then the forecasted number of units in inventory at the expiration date is set as greater than the threshold in Step 293. Specifically, the forecasted number may be set at the same number as the number of units currently in inventory under the assumption that no additional units will be sold. Alternatively, the forecasted number may be set as a reduced number that is greater than the threshold under the assumption that only a minimal number of additional units will be sold.

Conversely, in Step 291, if a determination is made that the time of last sale is less than a predefined amount, then the forecasted number of units remaining in inventory is set as less than the threshold in Step 295. Specifically, the forecasted number may be set under the assumption that all or most units will be sold.

The above frequency based and time based methods are only examples of potential methods that may be used to forecast the number of units in inventory at the expiration date. Other methods may be used without departing from the scope of the invention.

Regardless of whether frequency or time based method is used for forecasting the number of units in inventory at the expiration date, in Step 297, a determination is made whether the forecasted number of units is greater than the threshold number of units. If the forecasted number of units is greater than the threshold number of units, then a notification may be generated.

In Step 301, the consequences for having the inventory item remaining in inventory are calculated in one or more embodiments of the invention. The consequences may include loss interest on the money earned if the inventory item were sold now as opposed to an expected future date, loss of the ability to claim as an expense in taxes obsolete, overstocked, or unsalable inventory because the inventory item is not sold or otherwise disposed of, costs to maintain storage space for storing the inventory item, and other costs.

In Step 303, in one or more embodiments of the invention, the urgency level for the notification is calculated. Specifically, the urgency level may be based on the consequences, the amount of time until the inventory item expires, and other such factors.

In Step 305, a notification is generated using the consequences and the urgency level. Specifically, the notification may include the consequences, the urgency level, and a description of the inventory item. The notification may be generated according to the merchant's preferences.

In Step 307, a determination is made whether to check another inventory item. If a determination is made to check for another inventory item, then the inventory item is identified.

Although not shown in FIG. 5, if a notification has been issued for an inventory item, the inventory management application may determine, based on the rate (discussed above), how the inventory item is selling. In particular, the inventory management application may forecast the number of units remaining in inventory at the expiration date according to the rate. If the number of sales increases such that the urgency level is reduced or such that at most only the threshold number of units is forecasted to remain in inventory at the expiration date, then the inventory management application may notify the merchant of the good news. Thus, the merchant may set a more restrictive buyer network, change the parameters for the sale, or remove the offer of the inventory item on the merchant transaction system.

Although not shown in FIG. 5, if the result of the forecasting is an amount of demand that the merchant is unable to fulfill, the merchant may be notified of the potential to not fulfill the demand. Based on the notification, the merchant may create a desired inventory item record in the merchant transaction system to be notified when the inventory item is available. Alternatively, the merchant may decide to reorder the inventory item from the merchant's supplier.

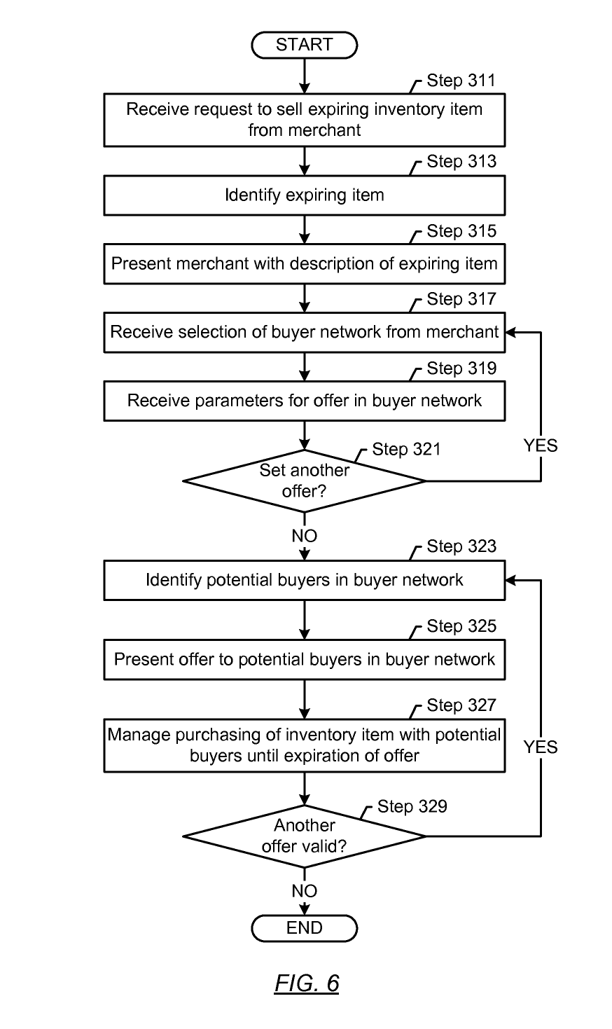

FIG. 6 shows a flowchart for the merchant transaction application to sell an inventory item via the merchant transaction system in accordance with one or more embodiments of the invention. In Step 311, the merchant transaction system receives a request to sell expiring inventory items from a merchant. For example, the merchant may access the merchant transaction system to sell an expiring inventory item. The request may be received by the merchant following the link from the inventory management application to the merchant transaction system. The link may pre-populate the merchant transaction system with the required information for the offer. Alternatively, the merchant submits at least some of the information. Accordingly, in one or more embodiments of the invention, the merchant transaction system identifies the expiring inventory item in Step 313.

In Step 315, in one or more embodiments of the invention, the merchant transaction system presents the merchant with a description of the expiring inventory item. By presenting the merchant with the description, the merchant is assured that the merchant is offering the correct inventory item for sale via the merchant transaction system.

In Step 317, the merchant transaction system receives a selection of a buyer network from the merchant. For example, the merchant may select required attributes of potential buyers in the buyer network. Alternatively, the merchant may select the buyer network from a list of pre-defined buyer networks. Rather than the merchant selecting the buyer network, the merchant may use a default buyer network, such as a buyer network defined by the merchant in the merchant's preferences.

In Step 319, the merchant transaction system receives parameters for an offer in the buyer network. In one or more embodiments of the invention, the parameters may include the timeframe in which the offer is valid, price, number of items in the inventory for the offer to remain valid, and other parameters.

In one or more embodiments of the invention, rather than the merchant defining a price for the item, the merchant may decide to sell the item by an auction. In such embodiments, the merchant may set a parameter specifying the merchant's reserve price (e g., minimum price the merchant is willing to accept) and the buyers in the buyer network may bid on the item via the merchant transaction system.

In Step 321, a determination is made whether the merchant wants to create another offer. For example, as the expiration date of the inventory items approaches, the merchant may decide to generate a less restrictive offer. If the merchant selects to generate another offer, then the merchant transaction application guides the merchant through generating another offer.

After one or more offers are generated, the merchant transaction system sells the inventory item. Specifically, in Step 323, the merchant transaction system identifies potential buyers in the buyer network. More specifically, the merchant transaction system may access account settings for each of the accounts in the merchant transaction system to obtain the attributes of the account owner. If the attributes of the account owner match the attributes required by the buyer network, then the account owner is identified as a potential buyer.

In Step 325, the merchant transaction system presents the offer to the potential buyer. For example, the merchant may access the potential buyers account to determine whether the inventory item matches a desired inventory item record of the potential buyer. If the inventory item matches a desired inventory item, then the merchant sends the offer to the potential buyer. As another example, when potential buyers peruse the merchant transaction system, the merchant transaction system may present the offer to the potential buyer.

In Step 327, the merchant transaction system manages the purchasing of inventory item with potential buyers until the expiration of the offer. Specifically, the offer may deem to expire according to the number of units of the inventory item remaining or the timeframe in which the offer is valid. When an inventory item is purchased via the merchant transaction system, the merchant transaction system updates the inventory management application. Similarly, the merchant transaction system receives updates from the inventory management application.

At the end of the time frame for the offer, the merchant transaction system determines whether another offer is valid in Step 329 in one or more embodiments of the invention. If another offer is valid, then the merchant transaction system continues to sell inventory item under the next offer starting with Step 323.

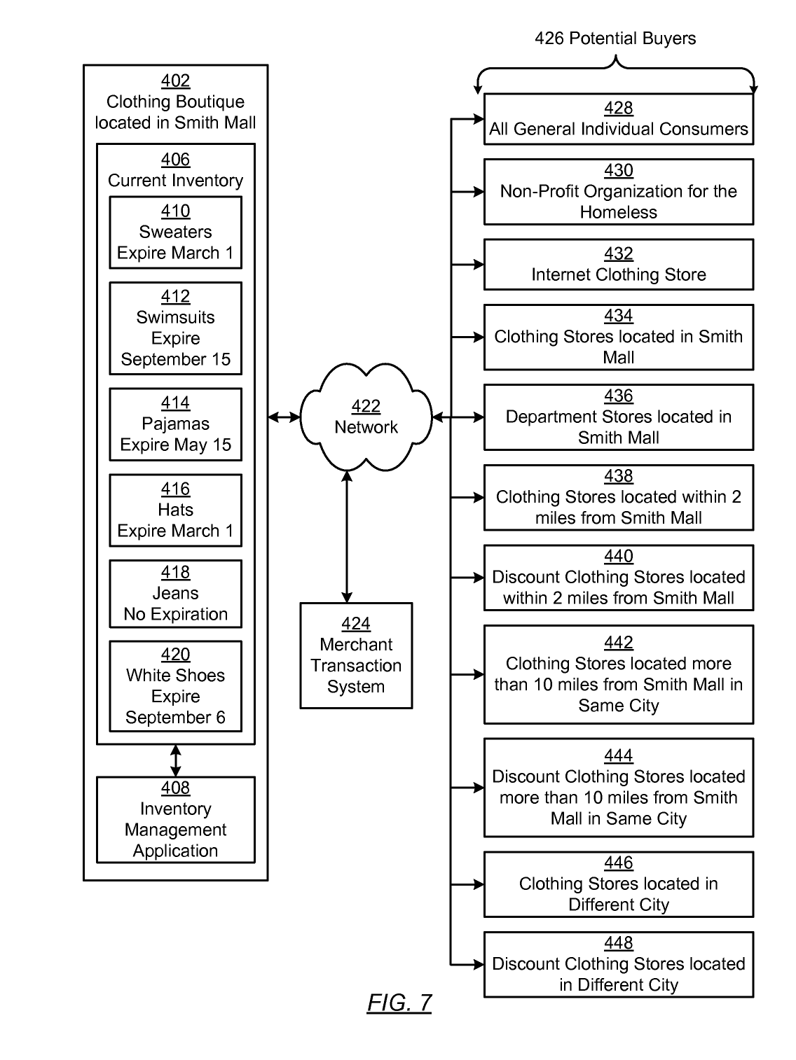

FIG. 7 shows an example in accordance with one or more embodiments of the invention. The following example is for explanatory purposes only and not intended to limit the scope of the invention. For the following example, consider the scenario in which the merchant is a clothing boutique store located at Smith Mall (402). The clothing boutique store is owned by Jane. In the example, the clothing boutique store is deemed to perform actions when Jane performs actions on behalf of the clothing boutique store. Similarly, the clothing boutique store is deemed to receive notifications when Jane receives notifications on behalf of the clothing store. The clothing boutique store uses an inventory management application (408) to manage the clothing boutique stores inventory. For the example, consider the scenario in which on August 15, Jane receives a product shipment of fall and winter clothes. She uses the inventory management application (408) to update her inventory records for the new shipment. Thus, the inventory records and the inventory include the boutique's new fall and winter clothes and existing summer clothes.

As shown in FIG. 7, in the example, the clothing boutique stores current inventory (406), as of August 15, includes sweaters that expire March 1 (410), swimsuits that expire September 15 (412), pajamas that expire May 15 (414), hats that expire March 1 (416), jeans that do not have an expiration (418), and shoes that expire September 6 (420). Because Jane must manage the boutique and her customers, Jane relies on the inventory management application (408) to keep track of her current inventory. Thus, the inventory management application (408) updates the inventory records when inventory items are sold.

Further, the inventory management application (408) periodically checks to determine whether any of the inventory items expire. On August 20, the inventory management application performs a check on inventory items that expire within the next month. Because the white shoes (420) expire on September 6, and the swimsuits (412) expire on September 15, the inventory management application obtains the sales prediction data for the white shoes (420) and the swimsuits (412). Based on the changes in frequency at which the white shows (420) are sold, the inventory management application forecasts that the Jane will have twenty pairs of white shoes (420) in her inventory on September 6. Further, because each pair cost the boutique sixty dollars, the boutique will lose one thousand two hundred dollars if she does not sell the white shoes. Similarly, the inventory management application (408) determines that the boutique will have ten bathing suits on September 15 at a total cost of five hundred dollars. Accordingly, the inventory management application sends a notification to Jane's mobile phone.

After viewing the notification, Jane realizes that she will not be able to sell the white shoes after Labor Day to the boutique's customers, so she decides to sell the white shoes via the merchant transaction system (424). Jane selects a link in the notification to access the merchant transaction system (424) via the network (422). The merchant transaction system (424) guides Jane through selling the white shoes.

Specifically, via the merchant transaction system (424) Jane can sell excess inventory to a variety of potential buyers (426). As shown in the example, the potential buyers may include general individual consumers (428), non-profit organization for the homeless (430), an internet clothing store (432), clothing stores located in Smith Mall (434), department stores located in Smith Mall (436), clothing stores located within two miles from Smith Mall (438), discount clothing stores located within two miles from Smith Mall (440), clothing stores located more than ten miles from Smith Mall (442), discount clothing stores located more than ten miles from Smith Mall (444), clothing stores located in a different city (446), and discount clothing stores located in a different city (448).

Continuing with the example, because Jane does not want to sell to her direct competitors or customers, Jane excludes general consumers (428) and all stores located in Smith Mall or two miles from Smith Mall. Further, Jane believes that having the Boutiques inventory items in a discount clothing store will lessen the price that she can sell her inventory items. Jane also is not ready to donate the inventory items. However, because of the urgency, Jane wants to sell to everyone else. Therefore, for the shoes, Jane sets the buyer network to be clothing stores located more than ten miles from Smith Mall (442) and clothing stores located in a different city (446). Jane further sets a price of the shoes as seventy dollars. Because the buyer network does not include the boutique's potential customers, Jane continues to sell the white shoes (420) at a price of one hundred and twenty dollars.

Continuing with the example, because the swimsuits are less urgent and have a lower cost as noted in the notification sent to Jane on August 20, Jane decides to set the buyer network to include clothing stores located in a different city (448). Accordingly, the merchant transaction system starts selling the white shoes to one buyer network and the swimsuits to the different buyer network.

Coincidentally, Barb's Fashion (not shown), a clothing store located in the different city, had sold out of swimsuits. Barb, the owner, was concerned that she would not have any swimsuits to sell to her customers for the Labor Day rush. She creates a desired inventory item record in the merchant transaction system (424) on August 15 for swimsuits. When Jane posts the offer on August 20, Barb is notified and immediately purchases the excess inventory of swimsuits from the boutique via the merchant transaction system (424). Accordingly, the merchant transaction system (424) sends a notification and payment to Jane for Barb's Fashion purchase of the ten excess bathing suits. Jane sends the ten bathing suits to Barb's Fashion. Further, the boutique's inventory management application (408) is updated to record the sale of the ten bathing suits. Because the clothing boutique and Barb's Fashion are not direct competitors, both clothing stores benefit from the deal.

Unfortunately, Jane is not so lucky with the white shoes (420). Rather, the inventory management application (408) performs another forecast on September 2 and estimates that the boutique will have thirty pairs of white shoes on the expiration date. Thus, on September 2, Jane receives an urgent notification that the white shoes need to be sold. Jane decides to update the buyer network at the merchant transaction system (424) to include all general individual customers (428). She also sets the price of the white shoes at the clothing boutique to be the same price available via the merchant transaction system (424). The merchant transaction system is able to sell twenty-five pairs of white shoes to brides getting married in September and October. With each pair sold, Jane is notified of the sale and the inventory management application (408) are updated. Jane ships the shoes to the respective brides.

On September 6, Jane decides that she will not be able to sell additional white shoes, so she updates the merchant transaction system (424) to include the non-profit organization (430) in the buyer network. Accordingly, the merchant transaction system (424) finds a non-profit organization that is looking for white shoes for their Christmas caroling outfits. After being notified, Jane donates the remaining shoes to the non-profit organization. Accordingly, Jane is able to dispose of excess inventory and benefit monetarily from the tax deduction.

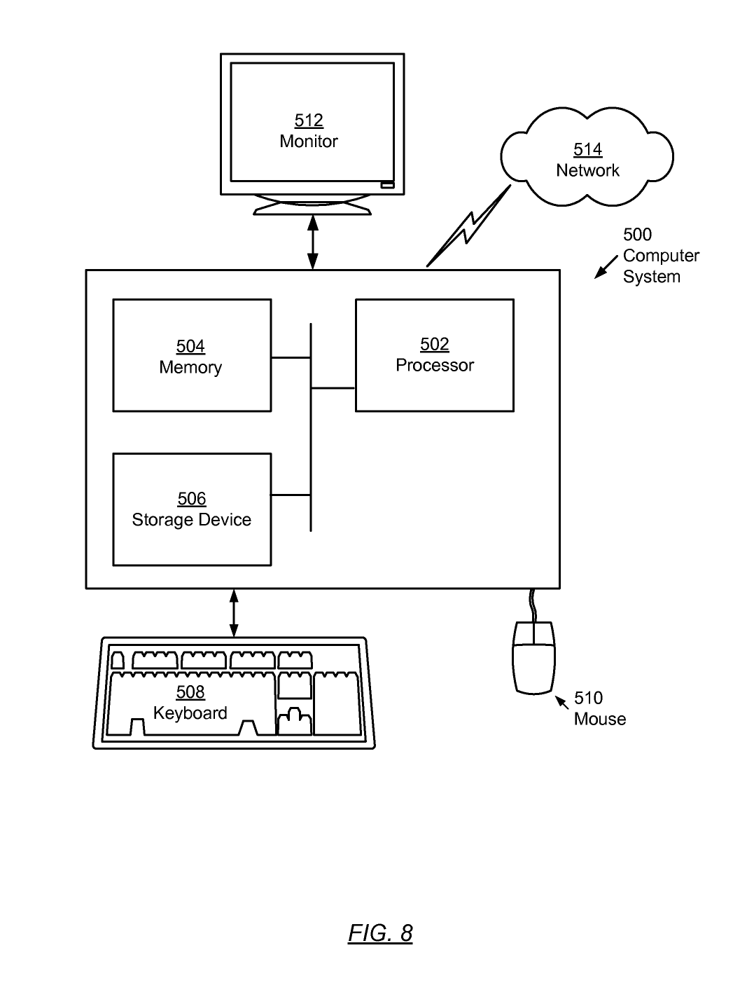

Embodiments of the invention may be implemented on virtually any type of computer regardless of the platform being used. For example, as shown in FIG. 8, a computer system (500) includes one or more processor(s) (502) such as an integrated circuit, a central processing unit (CPU), or other hardware processor, associated memory (504) (e.g., random access memory (RAM), cache memory, flash memory, etc.), a storage device (506) (e.g., a hard disk, an optical drive such as a compact disk drive or digital video disk (DVD) drive, a flash memory stick, etc.), and numerous other elements and functionalities typical of today's computers (not shown). The computer (500) may also include input means, such as a keyboard (508), a mouse (510), or a microphone (not shown). Further, the computer (500) may include output means, such as a monitor (512) (e.g., a liquid crystal display (LCD), a plasma display, or cathode ray tube (CRT) monitor). The computer system (500) may be connected to a network (514) (e.g., a local area network (LAN), a wide area network (WAN) such as the Internet, or any other type of network) via a network interface connection (not shown). Those skilled in the art will appreciate that many different types of computer systems exist, and the aforementioned input and output means may take other forms. Generally speaking, the computer system (500) includes at least the minimal processing, input, and/or output means necessary to practice embodiments of the invention.

Further, those skilled in the art will appreciate that one or more elements of the aforementioned computer system (500) may be located at a remote location and connected to the other elements over a network. Further, embodiments of the invention may be implemented on a distributed system having a plurality of nodes, where each portion of the invention (e.g., an inventory management application, merchant transaction application, data repository, merchant accounts, general consumer accounts, etc.) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions to perform embodiments of the invention may be stored on a non-transitory computer readable storage medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing excess inventory, comprising:
obtaining a description of an inventory item in an inventory of a merchant, a number of units of the inventory item, and an expiration date for the inventory item;
tracking sales of the inventory item by reducing a number of units of the inventory item in inventory according to the sales;
notifying, at a first predefined timeframe prior to the expiration date, the merchant when a forecast of the number of units of the inventory item remaining at the expiration date in the inventory is greater than a pre-defined threshold; and
referring the merchant to a merchant transaction system, wherein the merchant transaction system comprises functionality to:
present the merchant with a plurality of buyer networks for selling the inventory item,
receive, from the merchant, a selection of a first buyer network of the plurality of buyer networks to obtain a first selected buyer network, and
offer, at the first predefined timeframe prior to the expiration date, the inventory item for sale on the first selected buyer network.

2. The method of claim 1, wherein the merchant transaction system comprises further functionality to receive a plurality of parameters for selling the inventory item on the first selected buyer network.

3. The method of claim 2, wherein the plurality of parameters comprises an end time for offering the inventory item for sale on the first selected buyer network.

4. The method of claim 3, wherein the merchant transaction system comprises further functionality to:
receive, from the merchant, a selection of a second buyer network of the plurality of buyer networks to obtain a second selected buyer network, and
offer the inventory item for sale on the second selected buyer network after the end time for offering the inventory item for sale on the first selected buyer network.

5. The method of claim 4, wherein the second selected buyer network is less restrictive than the first selected buyer network.

6. The method of claim 1, wherein the first selected buyer network consists of merchants.

7. The method of claim 1, wherein the first selected buyer network is defined as merchants located in a specified geographic region.

8. The method of claim 1, wherein the first selected buyer network consists of merchants and non-profit organizations.

9. The method of claim 1, wherein the forecast of the number of unit of the inventory item remaining is based on at least one selected from the group consisting of time of last sale and frequency of units of inventory items sold.

10. The method of claim 1, wherein the notification comprises a listing of consequences of goods remaining in the inventory.

11. The method of claim 1, wherein the notification comprises an urgency indicator showing an urgency level based on the forecast, and wherein the urgency indicator of the notification shows an increased urgency level at a second predefined time frame.

12. The method of claim 11, wherein the urgency indicator is displayed as at least one selected from a group consisting of a monetary cost of the merchant not performing any action to address the forecast of the number of units of the inventory item remaining at the expiration date, and a monetary benefit of the merchant performing an action to address the forecast of the number of units of the inventory item remaining at the expiration date.

13. The method of claim 1, further comprising:
forecasting the number of units of the inventory item to obtain the forecast using historical data.

14. The method of claim 13, wherein the historical data is based on inventory item sales data gathered from merchants via the merchant transaction system.

15. A method for managing excess inventory, comprising:
receiving a physical shipment of goods;
submitting a description and expiration date of each inventory item in the physical shipment of goods to an inventory management application, wherein the inventory management application tracks number of units of each inventory item at the merchant; and
at a predefined timeframe prior to the expiration date:
receiving a notification when a forecast of the number of unit of an inventory item remaining in the inventory at the expiration date is greater than a pre-defined threshold,
selecting a buyer network of a plurality of buyer networks for selling the inventory item to generate a selected buyer network, and
selling the inventory item via the selected buyer network.

16. The method of claim 15, wherein the notification comprises an urgency indicator specifying an urgency level for selling the goods prior to the expiration date and consequences of the goods remaining in inventory.

17. The method of claim 16, wherein the urgency indicator is displayed as at least one selected from a group consisting of a monetary cost of the merchant not performing any action to address the forecast of the number of units of the inventory item remaining at the expiration date, and a monetary benefit of the merchant performing an action to address the forecast of the number of units of the inventory item remaining at the expiration date.

18. A system for managing excess inventory, comprising:
an inventory management application executing on a processor and configured to:
obtain a description of an inventory item in an inventory of a merchant, a number of units of the inventory item, and an expiration date for the inventory item,
track sales of the inventory item by reducing a number of units of the inventory item according to the sales, and
notify, at a first predefined timeframe prior to the expiration date, the merchant of the expiration date when a forecast of the number of unit of the inventory item remaining in the inventory is greater than a pre-defined threshold; and
a merchant transaction application executing on the processor and configured to:
present the merchant with a plurality of buyer networks for selling the inventory item,
receive, from the merchant, a selection of a first buyer network of the plurality of buyer networks to obtain a first selected buyer network, and
offer, at the first predefined timeframe prior to the expiration date, the inventory item for sale on the first selected buyer network.

19. The system of claim 18, further comprising
a merchant inventory management system comprising the inventory management application, and a data repository for maintaining inventory records.

20. The system of claim 19, wherein each inventory record comprises a description of the inventory item, a number of units of the inventory item, the expiration date, a sales prediction datum, and purchase information.

21. The system of claim 19, further comprising:
a point of sale hardware configured to:
obtain an identifier of an inventory item when a unit of the inventory item is sold, and
provide the identifier of the inventory item to the inventory management application to track the sale of the inventory item.

22. A computer readable storage medium comprising computer readable program code embodied therein for causing a computer system to perform a method for managing excess inventory, the method comprising:
obtaining a description of an inventory item in an inventory of a merchant, a number of units of the inventory item, and an expiration date for the inventory item;
tracking sales of the inventory item by reducing a number of units of the inventory item in inventory according to the sales;
notifying, at a first predefined timeframe prior to the expiration date, the merchant when a forecast of the number of units of the inventory item remaining at the expiration date in the inventory is greater than a pre-defined threshold; and
referring the merchant to a merchant transaction system, wherein the merchant transaction system comprises functionality to:
present the merchant with a plurality of buyer networks for selling the inventory item,
receive, from the merchant, a selection of a first buyer network of the plurality of buyer networks to obtain a first selected buyer network, and
offer, at the first predefined timeframe prior to the expiration date, the inventory item for sale on the first selected buyer network.

23. The computer readable storage medium of claim 22, wherein the merchant transaction system further comprises functionality to receive a plurality of parameters for selling the inventory item on the first selected buyer network.

24. The computer readable storage medium of claim 23, wherein the plurality of parameters comprises an end time for offering the inventory item for sale on the first selected buyer network.

25. The computer readable storage medium of claim 24, wherein the merchant transaction system further comprises functionality to:
receive, from the merchant, a selection of a second buyer network of the plurality of buyer networks to obtain a second selected buyer network, and
offer the inventory item for sale on the second selected buyer network after the end time for offering the inventory item for sale on the first selected buyer network.

26. The computer readable storage medium of claim 25, wherein the second selected buyer network is less restrictive than the first selected buyer network.

27. The computer readable storage medium of claim 22, wherein the first selected buyer network consists of merchants.

28. The computer readable storage medium of claim 22, wherein the first selected buyer network is defined as merchants located in a specified geographic region.

29. The computer readable storage medium of claim 22, wherein the first selected buyer network consists of merchants and non-profit organizations.

30. The computer readable storage medium of claim 22, wherein the forecast of the number of unit of the inventory item remaining is based on at least one selected from the group consisting of time of last sale and frequency of units of inventory items sold.

31. The computer readable storage medium of claim 22, wherein the notification comprises a listing of consequences of goods remaining in the inventory.

32. The computer readable storage medium of claim 22, wherein the notification comprises an urgency indicator showing an urgency level based on the forecast, and wherein the urgency indicator of the notification shows an increased urgency level at a second predefined time frame.

33. The computer readable storage medium of claim 32, wherein the urgency indicator is displayed as at least one selected from a group consisting of a monetary cost of the merchant not performing any action to address the forecast of the number of units of the inventory item remaining at the expiration date, and a monetary benefit of the merchant performing an action to address the forecast of the number of units of the inventory item remaining at the expiration date.

34. The computer readable storage medium of claim 22, wherein the method further comprises:
forecasting the number of units of the inventory item to obtain the forecast using historical data.

35. The computer readable storage medium of claim 34, wherein the historical data is based on inventory item sales data gathered from merchants via the merchant transaction system.

36. A computer readable storage medium comprising computer readable program code embodied therein for causing a computer system to perform a method for managing excess inventory, the method comprising:
receiving a physical shipment of goods;
submitting a description and expiration date of each inventory item in the physical shipment of goods to an inventory management application, wherein the inventory management application tracks number of units of each inventory item at the merchant; and
at a predefined timeframe prior to the expiration date:
receiving a notification when a forecast of the number of unit of an inventory item remaining in the inventory at the expiration date is greater than a pre-defined threshold,
selecting a buyer network of a plurality of buyer networks for selling the inventory item to generate a selected buyer network, and
selling the inventory item via the selected buyer network.

37. The computer readable storage medium of claim 29, wherein the notification comprises an urgency identifier specifying an urgency level for selling the goods prior to the expiration date and consequences of the goods remaining in inventory.

38. The computer readable storage medium of claim 37, wherein the urgency indicator is displayed as at least one selected from a group consisting of a monetary cost of the merchant not performing any action to address the forecast of the number of units of the inventory item remaining at the expiration date, and a monetary benefit of the merchant performing an action to address the forecast of the number of units of the inventory item remaining at the expiration date.
